(19) United States
(12) Patent Application Publication
(10) Pub. No.: US 2016/0337232 A1
(43) Pub. Date: Nov. 17, 2016

(54) FLOW-INDEXING FOR DATAPATH PACKET PROCESSING

(71) Applicants: PRASAD GORJA, Hyderabad (IN); SRINIVASA R. ADDEPALLI, San Jose, CA (US); SHAD I. ANSARI, San Jose, CA (US)

(72) Inventors: PRASAD GORJA, Hyderabad (IN); SRINIVASA R. ADDEPALLI, San Jose, CA (US); SHAD I. ANSARI, San Jose, CA (US)

(21) Appl. No.: 14/709,475

(22) Filed: May 11, 2015

(51) Int. Cl. H04L 12/721; H04L 12/741

(52) U.S. Cl. CPC H04L 45/38; H04L 45/54

(57) ABSTRACT

A system for forwarding data in a computing environment captures a flow pattern created for a datapath for a data packet. A flow index table is created based on creation of the datapath. Consecutive data packets are forwarded based on matching of forwarding information of subsequent data packets with one or more flow entries in a table index in the flow index table. If there is no flow index table, then the subsequent data packets are forwarded by following one or more flow tables (lookup tables).

### BACKGROUND

The present invention relates generally to the flow of data packets in a processing environment, and, more particularly, to packet flow forwarding in a table driven datapath.

A datapath or a switch is a data processing unit including a collection of functional units like a central processing unit, controller, and so on. In data networks, a datapath performs data forwarding functions like routing and switching of data packets. A datapath achieves the data forwarding by managing the flow of data packets through a set of tables. Typically, a table driven datapath is a data processing unit that is programmed by a control unit. The data forwarding, through a set of tables, is controlled by the control unit.

Flow forwarding in a datapath involves multiple table lookups. A table lookup provides direction for forwarding the data from a source point to a destination point. A table lookup, thus, plays an integral role in determining an appropriate interface to which the data (data packet) is to be forwarded.

Providing support for one or more additional functions in a datapath typically involves adding one or more lookup tables. For example, a generic L3 (layer 3) router has at least 6 tables, namely, Port/VLAN (Port/Virtual Local Area Network), ACL/PBR (Access Control List/Policy Based Routing), FIB (Forwarding Information Base), multicast forwarding, ARP (Address Resolution Protocol). The number of tables increases with support of additional network functions like NAT (Network Address Translation), Firewall and Quality of Service (QoS). A typical full featured router may have around more than 20 tables. Additionally, table driven pipeline datapaths that are designed for finer-grain flow control compound the table lookup problem by increasing the number of tables and/or table sizes.

Although, multiple tables in the network provide a data flow to achieve the required functionality, increasing the number of table lookups increases the processing time, which affects the performance of the forwarding process.

Various strategies have been proposed and adopted for improving datapath throughput. One strategy is to increase the speed of performing a table lookup and thereby reducing the overall time consumed during the flow forwarding process. Table lookup speed may be increased by using parallel lookup means. This usually means that processing power must be increased. Yet another strategy is to use cache memory to reduce the table lookup time.

Existing solutions make datapaths more complex either by adding more processing capabilities like adding more processing power or adding parallel processing capabilities. As networks become more complex and elastic, there is a need for datapaths to adapt and change with the needs of the network. Thus, it would be advantageous if each datapath was dynamically programmable with a different number of tables based on the use-cases and network topologies.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a network including a system for forwarding data in a computing environment in accordance with an embodiment of the present invention;

FIG. 2 is a schematic block diagram of the system for forwarding data of FIG. 1 in accordance with an embodiment of the present invention;

FIG. 3 illustrates a flow of a data packet through flow tables of the data forwarding system shown in FIG. 2 in accordance with an embodiment of the present invention;

FIG. 4 illustrates a structure of a flow index table in accordance with an embodiment of the present invention;

FIG. 5 illustrates creation of a datapath using flow tables in accordance with an embodiment of the present invention;

FIG. 6 illustrates forwarding of data packets based on a flow index table in accordance with an embodiment of the present invention;

FIGS. 7 and 8 are flow charts of a method for forwarding data in a computing environment in accordance with an embodiment of the present invention; and

FIG. 9 is a schematic block diagram of a computing environment in which a method and system for forwarding data in accordance with an embodiment of the present invention are implemented.

### DETAILED DESCRIPTION OF THE INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

While aspects of described system and method for forwarding data in a computing environment may be implemented in any number of different computing systems, environments, and/or configurations, the embodiments are described in the context of the following exemplary system.

In accordance with one or more embodiments, reference would be made to following definitions throughout the present description for a purpose of explanation. The definitions are mentioned for explaining the one or more embodiments for which the intent is not to limit the scope of the present subject matter.

The following are definitions of certain words and phrases used throughout the specification:

Datapath: A datapath is a collection of units (hardware units or logic units or arithmetic units) that perform data processing operations.

Flow table: A flow table in a switch or router contains a set of flow entries and each flow entry includes match fields, and a set of packet processing operations to be applied to packets when there is a match for the match fields.

Table lookup: A process of finding a best possible matching path for the given match fields in a table. Multiple table lookups may be required in a flow forwarding (or traversal) while data packets are passing through the multiple tables.

Flow traversal pattern/Flow forwarding pattern/flow pattern: Packets are matched for match fields in a flow entry in a flow table. The packets are matched and forwarded across multiple tables, which in turn match on multiple flows. The multiple flows constitute a flow traversal pattern. The flow traversal pattern includes information of all matched flows while the packet traverses from a source point to a destination point. Matching a packet means the packet header fields and associated data on the interface the packet is received are matched for the matched fields in a flow entry.

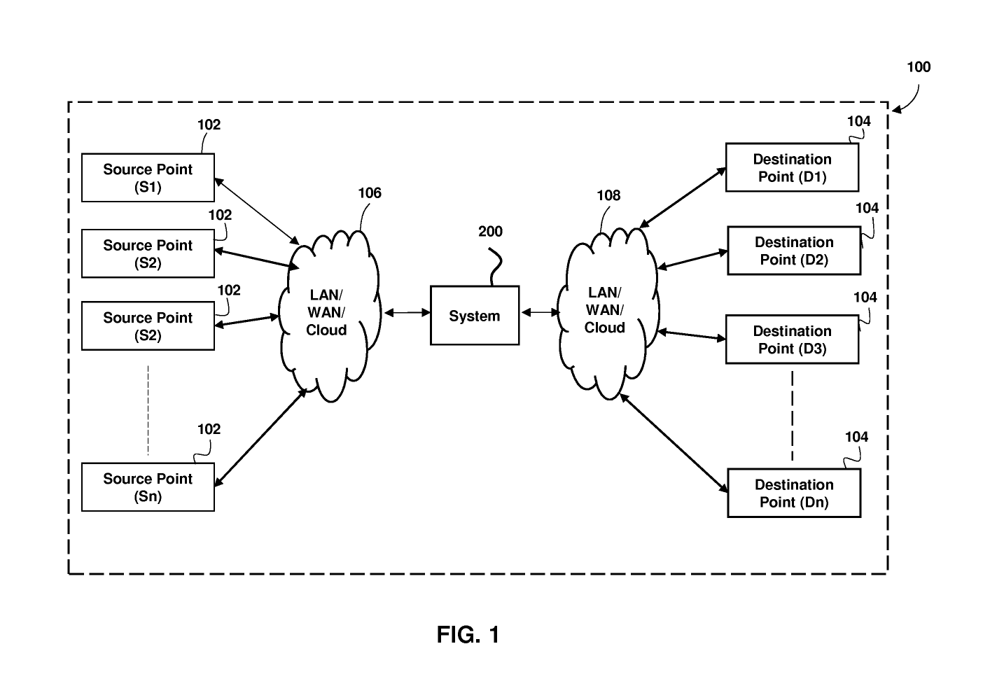

Referring now to FIG. 1, a computing environment 100 including a system 200 for forwarding data or data packets within the computing environment 100 is illustrated, in accordance with an embodiment of present invention. The computing environment 100 includes a plurality of source points 102 and a plurality of destination points 104. Data packets flow between the source points 102 and the destination points 104. The source and destination points 102, 104 may be connected to the system 200 in various ways, as will be understood by those of skill in the art, such as with wired, wireless, or combinations of connections. In FIG. 1, the source and destination points 102, 104 are connected to the system 200 via local area networks (LAN)/Wide Area Networks (WAN) or cloud environments 106 and 108.

The data packets contain forwarding information such as data packet origin and destination information. The forwarding of the data packets from a source point 102 to a destination point 104 involves following one or more flow tables (lookup tables). The flow tables may comprise software or hardware. Each flow table may include a rule (action set) for forwarding the data packets to the destination point 104 or to a control entity in accordance with instructions and actions programmed in the rules.

The system 200 for forwarding data packets captures a data flow pattern for the data packets following the flow tables. The flow pattern occurs based on the action sets in the lookup tables and executed on the data packet. The system 200 maintains references of the data flow pattern in a flow index table. In one embodiment, a flow index table is maintained for each datapath, where the flow index table is maintained upon creation of the datapath.

The flow index table may be used for forwarding one or more subsequent data packets without following the flow tables. Thus, the flow index table avoids further lookups in the flow tables by providing the reference to flow tables. The flow tables store flow entries that are followed for forwarding the data packet. The flow index table has one or more flow index entries like flow_index [k−1], flow_index [k] and flow_index [k+1], etc. A flow index entry consists of a set of match fields and one or more table index references. A table index node includes a table id, and a reference to the flow (not the flow itself). The data packets are matched with the match fields and upon matching, the instructions in the flow entry are executed. If there is no flow index table, the data packets are forwarded according to flow tables (following one or more flow tables). The flow tables provide action sets to be executed by one or more data forwarding units in order to forward the data packet.

Although the present invention is explained considering that the system 200 is implemented as a system for forwarding data in a network, it may be understood that the system 200 may also be implemented in a variety of computing systems, such as a laptop computer, a desktop computer, a notebook, a workstation, a mainframe computer, a server, a network server, an embedded system and the like. It should be understood that the system 200 may be accessed by multiple users through one or more user devices, or applications residing on the user devices. Examples of user devices may include, but are not limited to, a portable computer, a personal digital assistant, a handheld device, an embedded system, and a workstation. The user devices are communicatively coupled to the system 200 through a network. In accordance with an example embodiment, the system 200 may include routers, bridges, gateways, firewalls, and/or switches.

In one embodiment, the network may be a wireless network, a wired network or a combination thereof. The network may include telephone network, electronic data networks, (such as internet) and transportation network. The network may be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), mobile networks and the like, to communicate with one another. Further the network may include a variety of network devices, including routers, bridges, servers, computing devices, storage devices, and the like.

The source points 102 (S1, S2 . . . Sₙ) may include one or more computing devices and the destination points 104 (D1, D2 . . . Dₙ) may also include one or more computing devices. In one embodiment, the source and destination points 102, 104 include general purpose computers, laptop computers, tablet devices, or smart phones.

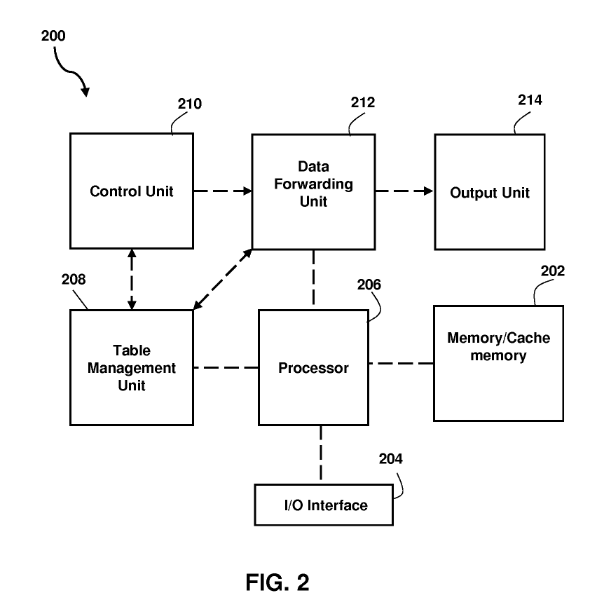

Referring now to FIG. 2, a schematic block diagram of the system 200 is shown. The system 200 includes a memory 202, an input/output (I/O) interface 204, at least one processor 206, one or more units such as table management unit 208, a control unit 210, a data forwarding unit 212, and an output unit 214. The processor 206 may be implemented as one or more microprocessors, microcomputers, microcontrollers, digital signal processors, central processing units, state machines, logic circuits, and/or any devices that manipulate signals based on instructions. Among other capabilities, the processor 206 can fetch and execute computer-readable instructions stored in the memory 202.

The I/O interface 204 may include a variety of software and hardware interfaces, for example, a web interface, a graphical user interface, and the like. The I/O interface 204 allows the system 200 to interact with a user directly or through client devices. Further, the I/O interface 204 may enable the system 200 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 202 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 202 may include modules and data. The table management unit 208, the control unit 210, the data forwarding unit 212 and the output unit 214 may include software modules or hardware units in accordance with various embodiments of the present invention.

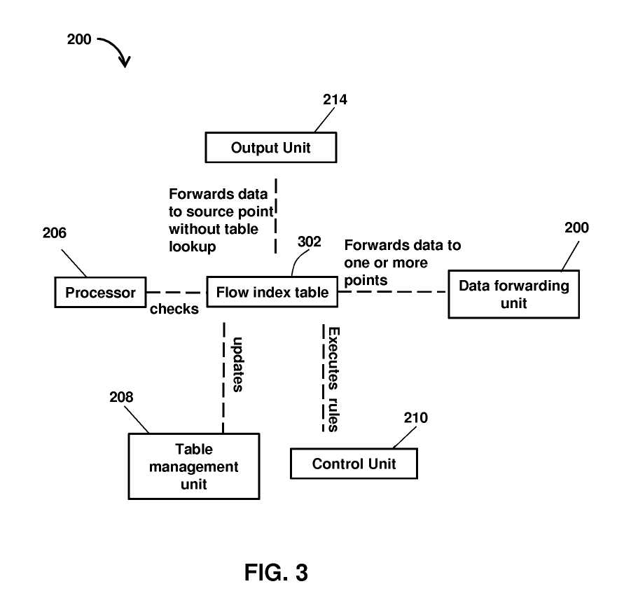

Referring to FIG. 3, a flow of a data packet through flow tables of the data forwarding system 200 is shown. In this embodiment, the system 200 includes a flow index table 302. The flow index table 302 is implemented and managed by the table management unit 208. The flow index table 302 comprises at least one of a Longest Prefix Match (LPM) table, an exact match table, and a wildcard/ACL match table. In another embodiment, the flow index table 302 is created based on creation of a datapath in the computing environment 100, and comprises a software module or a hardware unit.

In order to forward data packets from a source point 102 to a destination point 104, the processor 206 detects whether or not there is a flow index table 302. The detecting comprises checking for either the existence or non-existence of a flow pattern stored in the flow index table 302 as one or more flow indexes. The capture of the flow pattern and creation of the flow index table 302 based on the creation of the datapath is controlled by the control unit 210. The control unit 210 may be present within the system or the control unit 210 may be an external unit.

The control unit 210 is also configured to synchronize the flow entries of the flow index table 302 in the datapath with the flow indexes in the flow index table 302. The synchronization is performed using an index cookie for each of the flow entries. The flow index table comprises a field for storing the index cookie. The index cookie is assigned when the index flow entry in the flow index table is created. The index cookie is copied from the flow entry of the flow table into the flow index table. The index cookie is modified if the flow entry is modified. If there are any modifications, the control unit 210 updates the one or more flow index entries stored in the flow index table 302 with the help of the table management unit 208.

The flow index table 302 stores one more flow table indexes (or simply table indexes). The data forwarding unit 212 matches the forwarding information of the data packet with the one or more flow index entries in the one or more table indexes to obtain matched table indexes. The output unit 314 forwards the data packets based on the matching of the flow index entries (matched table indexes). The flow index table stores references of the data flow pattern in the flow index table (referenced lookup table). The data forwarding unit 212 matches the data with the flow entry in the flow index table to provide a flow reference of the one or more lookup tables in order to identify a destination. The flow reference provides a reference to the lookup tables without following the lookup tables. The data forwarding unit 212 executes a set of instructions according to the action sets in the one or more look up tables (also referred as reference tables) based on the flow reference to forward the data to an identified destination. The lookup tables are referred as the reference tables as the reference tables provide a reference to the action sets to be executed without following the lookup table.

If the processor 206 detects the non-existence of the flow index table 302 in the system 200, all the data packets follow a flow table to reach a destination point.

In either case, existence or non-existence of the flow index table, detected by the processor 206, a first data packet follows the flow table 302 to reach a destination point 104. Based on creation of the datapath for the first data packet, the flow index table 302 is created and subsequent packets are forwarded by the output unit 214 using the flow index table 302.

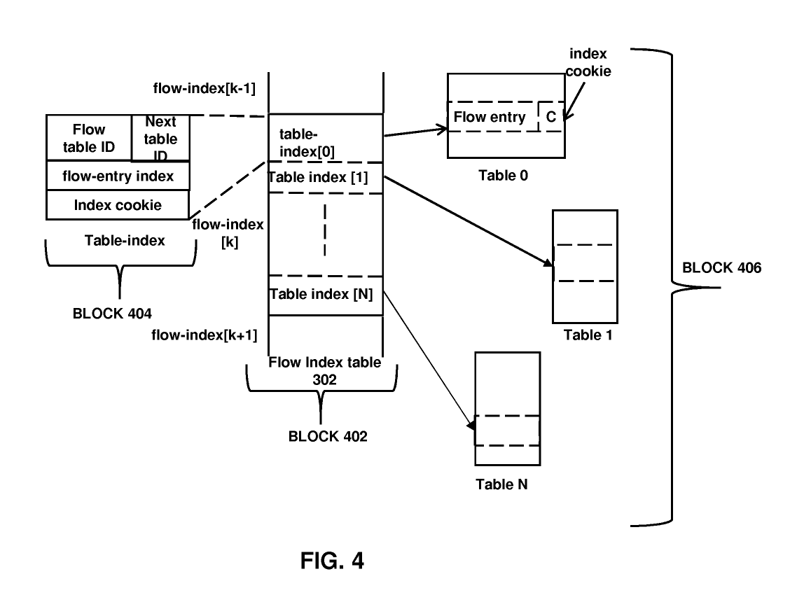

FIG. 4 illustrates details of the flow index table 302 created based on creation of the datapath of the first data packet. Block 402 shows an illustrative structure of the flow index table 302. The flow index table 302 is configured by the system 200 based on the flow pattern followed by the first data packet data to reach the destination point by following the one or more flow tables. The flow index table 302 may comprise a plurality of table indexes, such as table indexes table index[0], table index[1]. . . table index[N]. The plurality of table indexes may include multiple flow index entries.

Each of the table index comprises at least one of an identifier of a flow table being indexed, an index to a flow entry in the flow table being indexed, an identifier to next table to lookup after the flow table being indexed and the index cookie (or flow index cookie). Block 404 illustrates table index[0], which includes an index cookie, a flow-entry index, a flow table ID and a next table ID.

In one embodiment, the flow index table 302 comprises a Port/VLAN table, an ACL/PBR table, Forwarding Information Base (FIB) table, Adjacency table and Quality of Service (QoS) table. The first data packet follows the one or more tables for selecting a path in a network.

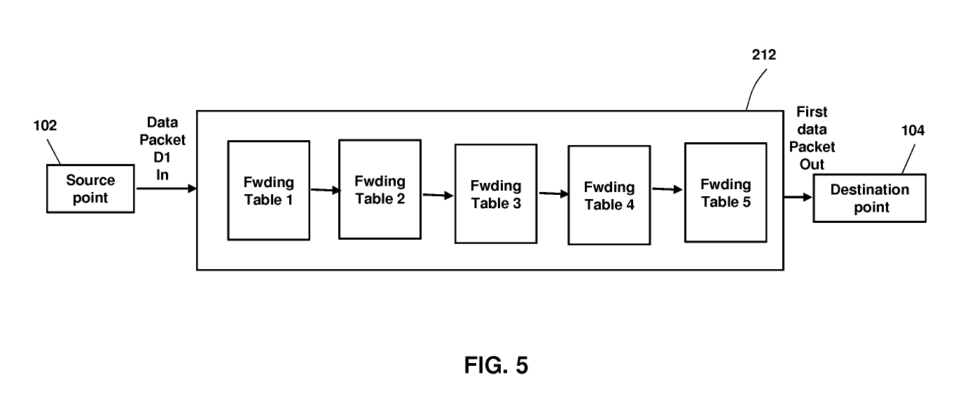

Referring to FIG. 5, in case of the non-existence of the one or more flow index tables 302 detected by the processor 206, the data forwarding unit 212 follows one or more flow tables (1, 2, 3 . . . 5) and based on the lookup tables, the output unit 214 forwards the data packet (D1) to the destination point.

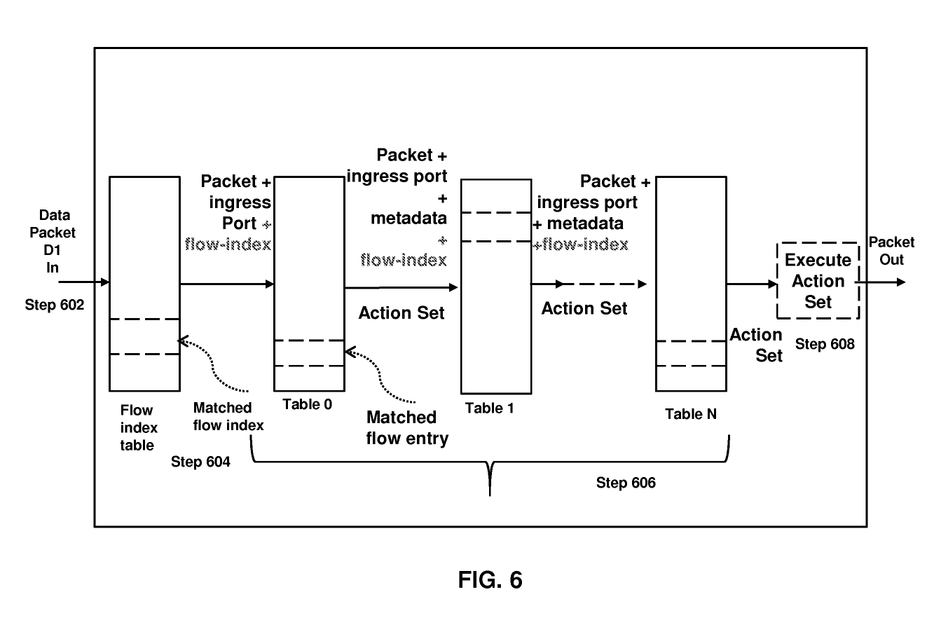

In accordance with an embodiment, referring to FIG. 6, the processor 206 confirms the checking of the flow index table 302 by detecting the table indexes in the flow index table 302. A data packet D1 enters into the system 200 (step 602). The data forwarding unit 212 checks for one or more table indexes to be matched with the forwarding information of the data packet D1 (step 602). The data forwarding unit 212 matches the data packet D1 with multiple flow index entries as per table 0, table 1 . . . table N (step 604). The data forwarding unit 210 executes the action set (set of instructions) to forward the data packet D1 to the destination point without following the one or more flow tables (step 606). The table indexes in the flow index table 302 are validated based on the index cookie. The index cookie is matched with cookie value of the flow entry. The matching of the index cookie with the cookie value of the flow entry validates the flow index.

Step 608 of FIG. 6 shows that the data output 214 unit is configured to forward the data packet as per the set of instructions (multiple set of instructions) executed by the data forwarding unit 212. The output unit 214 is configured to forward the data to the destination point.

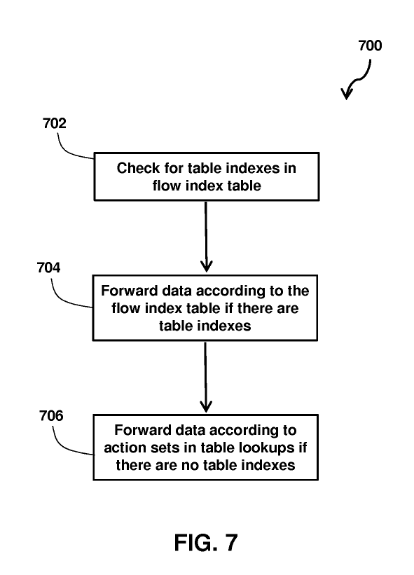

Referring now to FIG. 7, a method 700 for forwarding data in a computing environment is shown, in accordance with an embodiment of the present subject matter. The method 700 may be described in the general context of computer executable instructions. Generally, computer executable instructions may include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the subject matter described herein. Furthermore, the method can be implemented in any suitable hardware, software, firmware, or combination thereof. However, for ease of explanation, in the embodiments described below, the method 700 may be considered to be implemented in the above described system 200.

At step 702, the method 700 includes checking for one or more table indexes in a flow index table 302 to obtain a matched table index. The one or more table indexes are checked for matching forwarding information of the data packet with the one or more table indexes. In one embodiment, the processor 206 (as shown in FIG. 2) may check for one or more table indexes in the flow index table 302 (as shown in FIG. 3).

At step 704, the method 700 includes forwarding data according to the matched table indexes found in the flow index table 302 when one or more matching table indexes are found in the flow index table 302. In one embodiment, the data forwarding unit 212 (as shown in FIG. 2) matches the table indexes with the forwarding information of the one or more data packets. Based on matching, the data forwarding unit 212 executes a set of instructions and the output unit 214 (as shown in FIG. 2) may forward the data to the destination point.

The flow index table 302 stores one more flow table indexes (or simply table indexes). The data forwarding unit 212 matches the forwarding information of the data packet with the one or more flow index entries in the one or more table indexes. The output unit 314 forwards the data packets based on the matching of the flow index entries (matched flow index entries). The flow index table stores references of the data flow pattern in the flow index table (referenced lookup table). The data forwarding unit 212 matches the data with the flow entry in the flow index table to provide a flow reference of the one or more lookup tables in order to identify a destination. The flow reference provides a reference to the lookup tables without following the lookup tables. The data forwarding unit 212 executes a set of instructions according to the action sets in the one or more look up tables (also referred as reference tables) based on the flow reference to forward the data to an identified destination. The lookup tables are referred as the reference tables as they provide a reference to the action set to be executed without following the lookup table.

At step 706, the method 700 includes forwarding the one or more data packets according to action sets in one or more lookup tables if one or more matching table indexes are not found in the flow index table 302. In one embodiment, the processor 206 detects a non-existence of the table indexes in the flow index table 302 based on checking. The table management unit 208 enables the following of the one or more flow tables 302 by the data packet. The data forwarding unit 212 executes the set of instructions stored in the one or more flow tables followed by the data. Based on the execution, the output unit 214 forwards the data to the destination point.

In accordance with an embodiment, the method 700 also provides checking for a mismatch of flow entry with one or more table indexes. The checking of the mismatch comprises checking for at least one of an addition of a table entry (flow entry) in the one or more flow tables, and a removal of the table entry in the one or more flow tables.

The data packet is then forwarded according to action sets in one or more lookup tables. The method 700 provides updating the one or more table indexes for the forwarding of the data packet in case of the mismatch.

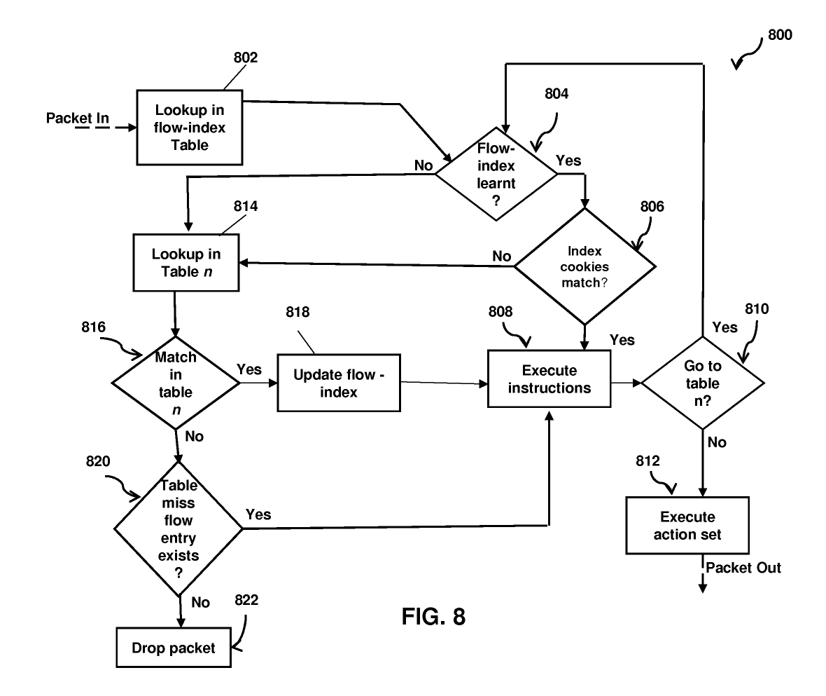

Referring to FIG. 8, the method 800 in step 802 includes checking for a lookup in the flow index table 302. The lookup in the flow index provides one or more table indexes to be matched with the forwarding information of the data packet.

At step 804, the method 800 includes checking for any updates and modifications performed in the table indexes based on match of the cookie value of the flow entry with an index cookie, at step 806. The index cookie is assigned when the flow entry in the flow index table is created. The index cookie is copied from the flow entry into the flow index table. The index cookie is modified in case of any modification in the flow entry. In case of any modification, the control unit 210 is configured to update the one or more flow index entries stored in the flow index table 302 with the help of the table management unit 208.

At step 808, the method 800 includes executing instructions based on matching of the table indexes with the forwarding information of the data. At step 810, the method 800 includes executing set of instructions without following the one or more flow tables. The data is forwarded to the destination point.

The method 800 includes forwarding the data based on the flow index table in case there are no updates and table index validation is not required. At step 814, the method 800 includes following table look up in case of non-existence of the flow index table 302. At step 816, the method 800 matches the forwarding information of the data packet with routing records in the flow tables. At step 818, the method 800 includes updating the flow index table 302 with a flow pattern. The flow pattern is obtained from a first data packet following the one or more flow tables in case of the non-existence of the flow index tables. The flow pattern occurs based on the action sets in the one or more lookup tables and executed on the data packet. Based on creation of the datapath of the first data packet, the flow index table 302 is created. Based on any updates in the flow index table 302, the data packet is forwarded in accordance with the one or more flow entries updated in the flow index table (step 808, 810 and 812).

At step 820, the method 800 checks if there is any table miss flow entry. The table miss flow entry exists in a case when the forwarding information of the data is not matching with the record routes stored in the flow tables.

At step 822, the method 800 includes dropping the data in case of existence of the table miss flow entry. In case there is no table miss flow entry, the data is forwarded according to steps 808, 810 and 812. Description of example embodiments for method 700 and 800 is same as described for system 200.

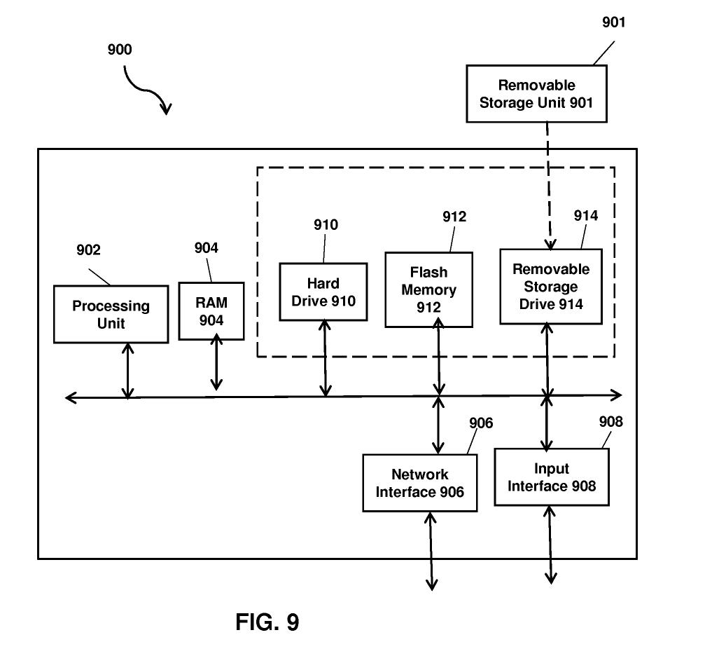

In accordance with an embodiment, FIG. 9 is a block diagram illustrating the details of the system 900 in which various aspects of the present subject matter operative by execution of appropriate software instructions. System 900 may correspond to system 200 for forwarding the data. System 900 may contain one or more processors such as central processing unit (CPU) 902, random access memory (RAM) 904, secondary memory, network interface 906, and input interface 908. All the components may communicate with each other over communication path, which may contain several buses as is well known in the relevant arts. The components of system 900 are described below in further detail.

CPU 902 may execute instructions stored in RAM 904 to provide several features of the present subject matter. CPU 902 may contain multiple processing units, with each processing unit potentially being designed for a set of action. Alternatively, CPU 902 may contain only a single general purpose processing unit. RAM 904 may receive instructions from the secondary memory using the communication path.

Secondary memory may contain a hard drive 910, flash memory 912, and removable storage drive 914. Secondary memory may store the data and software instructions (example, method for forwarding the data) which enable the system 900 to provide several features in accordance with the present subject matter. Some or all of the data and instructions may be provided on removable storage unit, and the data and instructions may be read and provided by the removable storage drive to CPU 902. Floppy drive, magnetic tape drive, CD-ROM drive, DVD drive, flash memory, removable memory chip are examples of removable storage unit.

Removable storage unit 901 may be implemented using medium and storage format compatible with removable storage drive such that removable storage drive may read the data and instructions. Thus, removable storage unit 901 includes a computer readable medium (computer readable medium may include a non-transitory computer readable medium) having stored therein computer software and/or data.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for forwarding a data packet from a source point to a destination point in a computing environment, the method comprising:
receiving a data packet and reading data in the data packet;
reading a table index from a flow index table, wherein the flow index table comprises a plurality of table indexes, wherein each table index comprises an index to a flow entry in the flow table being indexed;
checking the data for a match with the table index read from the flow index table to obtain a matched table index;
forwarding the data packet to the destination point according to the index to the flow entry of the matched table index found in the flow index table; and
forwarding the data packet to the destination point according to action sets in one or more lookup tables if no matched table index is found in the flow index table.

2. The method of claim 1, further comprising:
updating the flow index table with the table index based on a flow pattern of the data, wherein the flow pattern occurs according to the action sets in the one or more lookup tables; and
updating the flow index table with an index cookie.

3. The method of claim 1, wherein forwarding the data according to action sets comprises:
matching the data with a flow entry in the one or more lookup tables to identify the destination point; and
executing a set of instructions according the action sets to forward the data to the destination point.

4. The method of claim 3, wherein checking for a match with a table index comprises:
detecting the flow index table with the table index; and
checking if an index cookie of the flow index table matches a cookie value of the flow entry.

5. The method of claim 1, wherein forwarding the data according to the matched table index comprises:
matching the data with a flow index entry in the flow index table to provide a flow reference of the one or more lookup tables to identify a destination; and
executing a set of instructions according to the action sets in the one or more look up tables, based on the flow reference, to forward the data to the identified destination.

6. The method of claim 1, wherein the flow index table comprises at least one of a Longest Prefix Match (LPM) table, an exact match table, and a wildcard/ACL match table.

7. The method of claim 1, wherein each table index further comprises at least one of:
an identifier of the flow table being indexed;
an identifier to a next table to lookup after the flow table being indexed; and
an index cookie.

8. The method of claim 1, further comprising:
checking the data for a mismatch of a flow entry with the table index; and
updating the table index in the flow index table based on the forwarding according to the action sets in the one or more lookup tables.

9. The method of claim 8, wherein the checking for a mismatch comprises checking for at least one of an addition of a table entry in the flow table, and a removal of the table entry in the flow table.

10. A system for forwarding data in a computing environment, the system comprising:
a processor;
a memory coupled to the processor, wherein the processor is configured to execute a set of instructions stored in the memory, the set of instructions comprising:
checking the data for a match with a table index in a flow index table to obtain a matched table index, wherein the flow index table comprises a plurality of table indexes, wherein each table index comprises at least one of an index to a flow entry in the flow table being indexed, wherein the flow index table is stored in the memory;
forwarding the data according to the index to the flow entry of the matched table index; and
forwarding the data according to action sets in one or more lookup tables, if no matching table index is found in the flow index table, wherein the lookup tables are stored in the memory.

11. The system of claim 10, wherein the set of instructions further comprises:
updating the flow index table with the table index based on a flow pattern of the data, wherein the flow pattern occurs according to the action sets in one or more lookup tables; and
updating the flow index table with an index cookie.

12. The system of claim 10, wherein checking for a match with a table index comprises:
detecting the flow index table with the table index; and
checking if an index cookie of the flow index table matches a cookie value for a flow entry.

13. The system of claim 10, wherein forwarding the data according to action sets comprises:
matching the data with a flow entry in the one or more lookup tables to identify a destination; and
executing a further set of instructions to forward the data to the identified destination.

14. The system of claim 10, wherein forwarding the data according to the matched table index comprises:
matching the data with a flow index entry in the flow index table to provide a flow reference of the one or more lookup tables in order to identify a destination; and
executing a further set of instructions according to the action sets in the one or more look up tables, based on the flow reference, to forward the data to the identified destination.

15. The system of claim 10, wherein the flow index table comprises at least one of a Longest Prefix Match (LPM) table, an exact match table, and a wildcard/ACL match table.

16. The system of claim 10, wherein each table index further comprises at least one of:
an identifier of the flow table being indexed;
an identifier to next table to lookup after the flow table being indexed; and
an index cookie.

17. The system of claim 10, wherein the set of instructions further comprises:
checking for a mismatch of a flow entry with the table index;
forwarding the data according to the action sets in the one or more lookup tables; and
updating the table index in the flow index table based on the forwarding of the data according to the action sets in the one or more lookup tables.

18. The system of claim 17, wherein the checking for a mismatch comprises checking for at least one of an addition of a table entry in the flow table, and a removal of the table entry in the flow table.

19. A non-transitory computer readable medium storing a plurality of programs to be executed by one or more processors for forwarding data in a computing environment, the plurality of programs comprising:
a first program code for checking for a match with a table index in a flow index table to obtain a matched table index, wherein the flow index table comprises a plurality of table indexes, wherein each table index comprises at least one of an index to a flow entry in the flow table being indexed;
a second program code for forwarding data according to the index to the flow entry of the matched table index found in the flow index table; and
a third program code for forwarding data according to action sets in one or more lookup tables, if no matching table index is found in the flow index table.
